(19) United States
(12) Patent Application Publication
(10) Pub. No.: US 2017/0271969 A1
(43) Pub. Date: Sep. 21, 2017

(54) AXIAL ELECTRIC MOTOR

(71) Applicants: BENET SAFONT MARESMA, BARCELONA (ES); OLEKSIY TROFYMCHUK, BARCELONA (ES)

(72) Inventors: BENET SAFONT MARESMA, BARCELONA (ES); OLEKSIY TROFYMCHUK, BARCELONA (ES)

(21) Appl. No.: 15/365,125

(22) Filed: Nov. 30, 2016

(30) Foreign Application Priority Data
Mar. 15, 2016 (ES) 201630309

(51) Int. Cl. H02K 21/24; H02K 1/28; H02K 1/27

(52) U.S. Cl. CPC H02K 21/24; H02K 1/2793; H02K 1/28

(57) ABSTRACT

An axial electric motor which comprises a rotor (1) with a shaft (2) and a set of electromagnetic coils (3) situated between discs (4) of polarized magnets (5) which, in the manner of a stator (6), create the magnetic field which causes said coils (3) to rotate and with said coils, the shaft (2), each coil (3) being wound, to a steel core (7) which has a structural configuration which allows said cores (7) to be placed radially, forming a circle around the shaft (2) with a small spacing (8) therebetween and with the wires (31) of the winding arranged in a plane perpendicular to the longitudinal line of the shaft (2) and parallel to the discs (4).

### OBJECT OF THE INVENTION

The invention, as the title of the present specification states, relates to an axial electric motor which provides the operation for which it is intended with novel advantages and characteristics.

The object of the present invention is centered specifically on an axial three-phase electric motor/generator which, amongst other characteristics, is essentially distinguished by consisting of the rotor with electromagnetic steel coils in the form of a trapezoid which are installed radially forming a circle around the shaft and with winding wires situated transversal to the shaft, which, as the main difference with existing motors, determines that it has 1.7 to 2 times more power for the same energy consumption as an electric motor with the same quantity of coils and magnets installed.

### Application Field of the Invention

The application field of the present invention is framed within the sector of the industry dedicated to manufacturing electric motors and generators.

### BACKGROUND OF THE INVENTION

As is known, an electric motor is an electric machine which converts electric energy into mechanical energy by means of variable magnetic fields. Some electric motors are reversible, they can convert mechanical energy into electric energy, thus functioning as generators.

Inside said types of electric motors/generators, the rotors is the component which rotates and which, together with its fixed counterpart, the stator, forms the fundamental unit for power transmission.

The rotor comprises a shaft which supports a set of coils wound around a magnetic core which rotates within a magnetic field created either by a magnet or magnets or by the passage through another set of coils wound around polar pieces which remain static and which form what is termed a stator with a continuous or alternating current, depending on the type of machine concerned.

In this case, it concerns an axial motor, the rotor of which comprises a shaft which supports one or a plurality of coils wound around the core which, in known systems, are usually wound, forming a spiral around the annular body of said core when it adopts said shape or they are usually wound directly in the transversal direction around the external cylindrical surface thereof.

The objective of the present invention is thus to develop a novel type of axial motor in which the configuration of the core of the coils and the arrangement thereof is modified and they are designed improving the effectiveness of the electromagnetic field and consequently optimizing the power obtained.

In addition, as a reference to the current state of the art, it should be indicated that the existence of another similar motor or patent application presenting similar technical, structural and constructive characteristics to those claimed here is not known, at least on the part of the applicant.

### DESCRIPTION OF THE INVENTION

The axial electric motor which the invention proposes is thus configured as a novelty within the application field thereof since in accordance with the implementation thereof, the objectives indicated are satisfactorily achieved, the characterizing details making it possible and distinguishing it being expediently included in the final claims which accompany the present description.

Specifically, what the invention proposes, as has been noted above, is an axial three-phase electric motor/generator (hereinafter only referred to as motor) which, comprising in the rotor an electromagnetic winding which rotates with the shaft thereof housed between two discs provided with magnets which act as the stator, is distinguished essentially in that said winding is configured from multiple coils which each have a steel core which has a structural configuration preferably with a trapezoid base shape which allows them to be arranged radially and which form a circle around the shaft, the wound wires being arranged, in the winding thereof around each core, in a plane perpendicular to the longitudinal line of the shaft and parallel to the discs.

Furthermore, the cores described are fixed to the rotor by means of easily accessible screws, allowing the coils to be easily interchangeable. Preferably, each core is fixed by means of two screws which pass through it longitudinally and thread into securing rings provided for such purpose with holes matching the position of the through-holes of the cores.

It should also be mentioned that the cores of the coils, in addition to the described trapezoid base shape, have a transverse cross section in the form of a double T which determines two bases, upper and lower, wider than the central trunk in which the winding of the wires is implemented, the aforementioned through-holes for the fixing screws preferably being situated along said bases. When installing multiple motors following each other in order to increase the power, depending on the needs of each case, it is envisaged that said screws are fixed internally and externally.

In any case, the securing of the cores of the coils is carried out, at least with one exterior ring. The incorporation of a non-magnetic interior ring, for the spacing of the shaft to the coils is also preferably envisaged in which they are also optionally fixed with said screws.

Continuing with the particularities of the motor of the invention, it must be pointed out that the shaft of the rotor has holes for ventilation and for passing the cables, it also being envisaged that it has a two-way ventilation system which optimizes the effectiveness thereof.

To this end, especially the shaft, at least in the region thereof matching the winding, is formed by segments which, in addition to the cited holes, include a series of vanes distributed along the entire perimeter thereof which direct the direction of ventilation which passes through said holes, all of them, in the same segment, being directed in the same direction and, in adjacent segments, being directed in opposing directions, consequently the ventilation effect is much greater and therefore more effective.

Thus, the main advantages provided by the motor are:
Firstly, the fact that it provides between 1.7 and 2 times more power for the same energy consumption as a conventional electric motor with the same quantity of coils and magnets installed and is more powerful than the existing axial motors with circular coil or electric coils without steel.
The fact that the coils are easily removable, allowing the damaged coils to be replaced or for a change of power of the motor.
The fact that the pieces for securing the magnets can be easily manufactured with lightweight materials, depending on the use and power requirement.
The fact that the discs of the magnets have a 90% magnetic field in the interior of the rotor with the coils, all the power of the magnets and axial electric coils being utilized which function with the entire magnetic field produced, which, in turn increases the power of the motor, utilizing all the energy delivered to the motor.

It should lastly be mentioned that the motor described may be installed with shafts of different shapes, depending on the use of the motor and power requirement. The quantity of discs with magnets and coils may also be multiplied. Likewise, coils with greater wire capacity may installed in order to increase the power.

The axial electric motor described thus consists of an innovative structure with characteristics unknown up to now for the purpose for which it is intended. These reasons, which combined with the practical use thereof, provide the invention with sufficient justification to obtain the right of exclusivity which is requested.

### DESCRIPTION OF THE DRAWINGS

In order to complement the description being made and with the object of helping to better understand the characteristics of the invention, in accordance with a preferred practical embodiment thereof, said description is accompanied, as an integral part thereof, by a set of drawings where, in an illustrative and non-limiting manner, the following has been represented:

FIG. 1 shows a schematic elevated lateral view of the main parts of an example of the axial motor according to the invention specifically the shaft, the coils and the discs with magnets, the configuration and arrangement of the same being seen.

FIG. 2 shows a plan view of the same set of pieces of the motor of the invention shown in the preceding figure, the vertical shaft should be understood represented in this case with the exception of the discs and including the fixing screws of the coils, the trapezoid configuration of the cores thereof and the radial arrangement thereof around the shaft being seen.

FIG. 3 shows a plan view of one of the cores of the coils which comprises the motor of the invention, represented with the screws which pass through it for the fixing thereof, the trapezoid configuration of the upper and lower bases thereof being seen.

FIGS. 4, 5, 6 and 7 show views, respectively in lateral elevation, frontal and rear elevations and perspective view of the same exemplary core for the coils which the motor according to the invention has, represented in said figures without the winding of the coil and without fixing screw, the trapezoid configuration and double T section thereof being seen;

FIG. 8 shows a perspective view of the core of the coils which the motor of the invention has, in this case represented with the winding of the coil wound to the same on the double T section of the trunk thereof;

FIGS. 9 and 10 show views, in transverse cross section and in perspective of respective sections of the shaft in which the incorporation of holes and ventilation vanes arranged in opposing directions are seen; and

FIG. 11 shows a sectional view of another exemplary configuration of the motor of the invention, in this case an example of multiple motors with double set of coils and magnetic discs.

### PREFERRED EMBODIMENT OF THE INVENTION

In view of the mentioned figures, and in accordance with the numeration adopted, non-limiting examples of the axial electric motor of the invention may be seen in said figures, said motor comprises the parts and elements which are indicated and described in detail below.

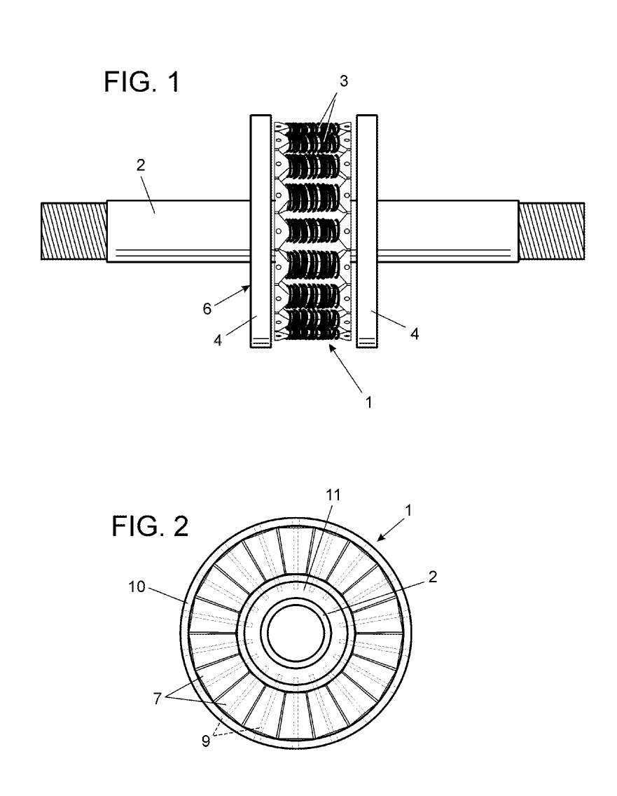

Thus, as is seen in FIG. 1, the motor in question, in addition to other components common to any axial three-phase electric motor which are not represented in the figures, comprises, in a known manner, a rotor (1) with a shaft (2) and a set of electromagnetic coils (3) situated between two discs (4) of polarized magnets (5) which, in the manner of a stator (6), create the magnetic field which causes said coils (3) to rotate and with said coils, the shaft (2), where said set of coils (3) are each wound, in an innovative manner, to a steel core (7) which has a structural configuration which allows said cores (7) placed radially around the shaft (2) and with the wires (31) of the winding arranged in a plane perpendicular to the longitudinal line of the shaft (2) and parallel to the discs (4).

As is observed in FIG. 2, the cores (7) of the coils (3) have a trapezoid base shape owing to which the set of the same form a circle around the shaft (2), a small spacing (8) existing between them.

These cores (7) are interchangeable since they are fixed to the rotor (1) by means of screws (9). Each core is preferably fixed by means of two screws (9) which pass through it longitudinally and thread into securing rings (10, 11) provided for such purpose; in at least one exterior ring (10) and optionally also in an interior ring (11) which is preferably a non-magnetic interior ring for the spacing of the shaft (2) to the coils (3).

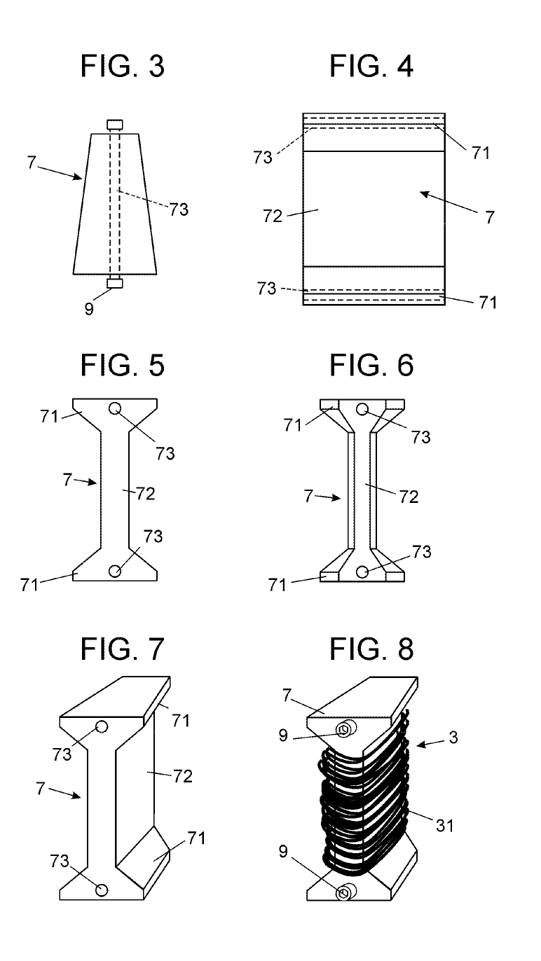

Concerning the FIGS. 3 to 8, it is seen how the cores (7) of the coils (3), in addition to having the trapezoid base shape, which makes them wider at the external side thereof than at the internal side and allows the radial arrangement thereof, forming the mentioned circle around the shaft (2), they have a transverse cross section in the shape of double T which determines two wide bases, upper and lower, (71) with a narrower central trunk (72) in which the winding of the wires (31) of the coil is implemented, said bases (71) being passed through longitudinally by respective holes (73) in order to insert the fixing screws (9).

Furthermore, the shaft (2) of the rotor (1) is equipped with a plurality of holes (12) for ventilation and for the passage of cables, holes (12) which are combined with means for guiding the two-way ventilation which optimizes the effectiveness thereof.

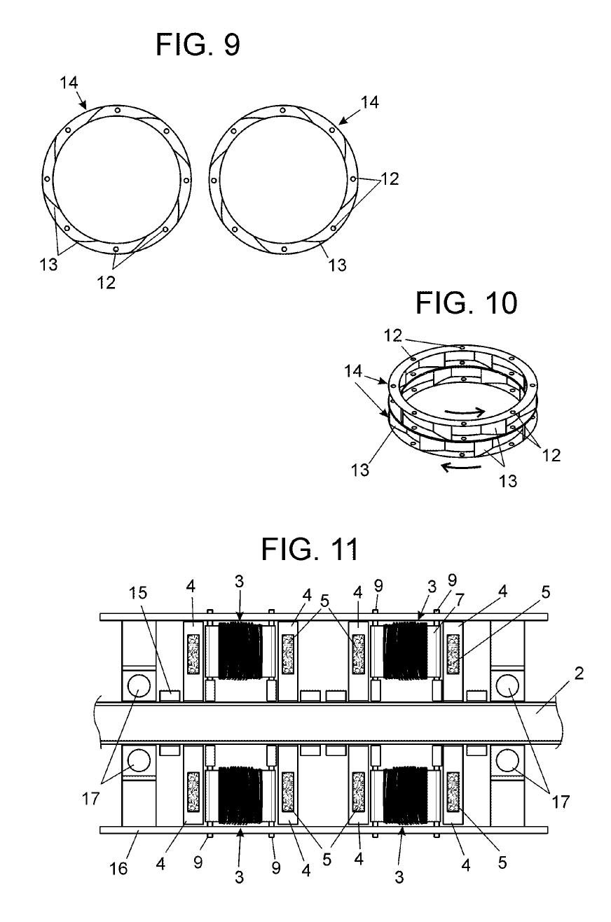

It should also be noted that said guide means of the ventilation are determined by the existence of a series of vanes (13) incorporated into segments (14) in which the shaft (2) is divided at least in the region of the coils (3), the vanes (13) of which are arranged distributed along the entire perimeter thereof, all the vanes (13), in a same segment (14), being directed in the same direction and, in adjacent segments (14), directed in opposing direction as is observed in FIGS. 9 and 10.

In FIG. 11, an exemplary alternative arrangement of the motor of the invention has been represented, where the shaft (2) of the rotor (1), instead of a group of coils (3) situated between two discs (4) of magnets (5) which would be the simple preferred embodiment shown in FIG. 1, envisages both groups of coils (3) interposed between respective pairs of discs (4) of magnets (5). Spacers (15), the body (16) of the motor and bearings (17) have also been included in this example, it should be indicated that the arrangement of said shaft (2) may also be variable according to the requirements of each case.

With the nature of the present invention sufficiently described as well as the manner of putting it into practice, it is not considered necessary to explain it further for a person skilled in the art to understand the scope thereof and the advantage derived therefrom, it must be stated that, within its essence, it may be put into practice in other embodiments which differ in detail from that indicated by way of example and to which the protection sought likewise extends, provided that the fundamental principle thereof is not altered, changed or modified.

1. An axial electric motor comprising a rotor (1) with a shaft (2) and a set of electromagnetic coils (3) situated between discs (4) of polarized magnets (5) which, in the manner of a stator (6), create the magnetic field which causes said coils (3) to rotate and with said coils, the shaft (2), is characterized in that the coils (3) are each wound, to a core (7) formed of steel which has a structural configuration which allows the core (7) to be placed radially, forming a circle around the shaft (2) with a small spacing (8) therebetween and with the wires (31) of the winding arranged in a plane perpendicular to the longitudinal line of the shaft (2) and parallel to the discs (4).

2. The axial electric motor according to claim 1, characterized in that the cores (7) of the coils have a trapezoid base shape.

3. The axial electric motor according to claim 1, characterized in that the core (7) is interchangeable with another core.

4. The axial electric motor according to claim 3, characterized in that the core (7) is fixed to the rotor (1) by screws (9).

5. The axial electric motor according to claim 4, characterized in that the core (7) is fixed by two screws (2) which pass through the core longitudinally and thread into at least one exterior ring (10) provided for such purpose.

6. The axial electric motor according to claim 5, characterized in that the core (7) is also fixed in an interior ring (11).

7. The axial electric motor according to claim 6, characterized in that the interior ring (11) to which the core (7) is fixed is a non-magnetic ring for the spacing of the shaft (2) to the coils (3).

8. The axial electric motor according to claim 1, characterized in that the core (7) has a transverse cross section in the form of a double T which determines two wide bases, upper and lower (71) with a narrower central trunk (72) in which the winding of the wires (31) of the coil (3) is implemented.

9. The axial electric motor according to claim 1, characterized in that the shaft (2) is equipped with holes (12) for ventilation and for passing cables which are combined using means for guiding the two-way ventilation.

10. The axial electric motor according to claim 9, characterized in that the means for guiding the ventilation are determined by vanes (13) incorporated into segments (14) into which the shaft (2) is divided at least in the region of the coils (3).

11. The axial electric motor according to claim 10, characterized in that the vanes (13) are arranged distributed along the entire perimeter of each segment (14) of shaft (2), all of the vanes (13) in the same segment (14) being directed in the same direction and, in adjacent segments (14), being directed in opposing directions.

12. The axial electric motor according to claim 1, characterized in that a group of coils (3) between two discs (4) of magnets (5) is coupled to the shaft (2).

13. The axial electric motor according to claim 1, characterized in that two groups of coils (3) are coupled to the shaft (2), each one of the two groups of coils (3) arranged between respective pairs of discs (4) of magnets (5).
